(19) United States
(12) Patent Application Publication
(10) Pub. No.: US 2024/0309168 A1
(43) Pub. Date: Sep. 19, 2024

(54) DEPOLYMERIZATION

(71) Applicant: KATHOLIEKE UNIVERSITEIT LEUVEN, Leuven (BE)

(72) Inventors: Wim THIELEMANS, Kortrijk (BE); Jose Jonathan RUBIO ARIAS, Kortrijk (BE)

(21) Appl. No.: 18/575,918

(22) PCT Filed: Jul. 1, 2022
(86) PCT No.: PCT/EP2022/068334

§ 371 Date: Jan. 2, 2024

(30) Foreign Application Priority Data
Jul. 2, 2021 (EP) 21183359.5

(51) Int. Cl. C08J 11/16

(52) U.S. Cl. CPC C08J 11/16; C08J 2367/02; C08J 2369/00; C08J 2377/00

(57) ABSTRACT

In accordance with the purpose of the invention, as embodied and broadly described herein, the invention is broadly drawn to the use of an alcoholic medium, for instance methanol medium with an alkaline, for instance an alkali hydroxide, as depolymerization agent without any further addition of organic solvents under microwave action (heating) to achieve almost instantaneous, for instance within 1-13 minutes, for almost 100%, for instance 98-99, 9%, depolymerization of polyethylene terephthalate structures or polycarbonate structures of any suitable shape and morphology such as flakes, fibers, powder, sheet, pellet, spheres, pearls, dendrites, discs or any other three-dimensional shape with a micrometric or millimetric dimension, singly or in combination if these are millinized structures, microsized structures, structures having a thickness up to 5 mm or structures having a maximum dimension of not more than 10 mm.

### BACKGROUND OF THE INVENTION

### A. Field of the Invention

The present invention relates generally to a method for depolymerization of polymers and, more particularly to a method for fast depolymerization, for instance depolymerization within a time frame of up to 15 minutes, of polymer structures such as but not limited to polyesters such as polyethylene terephthalate, and polycarbonate with micrometric or millimetric dimension or with less than 2 hours of such polymer structures that are otherwise difficult to depolymerize such as polyamides. The method of present invention is also particularly suitable for selectively depolymerizing mixtures of polymer structures with micrometric or millimetric dimension.

### B. Description of the Related Art

There is a need in the art for a method that depolymerizes polycarbonates (PC) and/or polyethylene terephthalate (PET) and other thermoplastic polyesters in instant ways, for instance within a few minutes which is achieved by present invention, for instance within 2 min. at temperatures in the range of 80-130° C.

There is also a need in the art for a method that depolymerizes polyamides within a reasonable time, for instance within 1.5 h which with the process of present invention was possible a temperature of 130° C. to 170° C., preferably 140° C.-160° C. and most preferably 145° C.-155° C.

And there is also a need in the art, for selective depolymerization of polycarbonate and polyesters, e.g., polyethylene terephthalate, from a heterogeneous polymer waste stream, preferably within a few minutes, for instance within 2 min.

Such has been demonstrated by present invention for instance on a heterogeneous polymer waste stream comprising polycarbonate and polyethylene terephthalate plus polyamides and polyolefins at temperatures 110-150° C., whereby from this waste stream feedstock bisphenol A, dimethyl carbonate, terephthalic acid, ethylene glycol followed by recovery of aminocaproic acid or hexamethylene diamine and adipic acid leaving unreacted polyolefins were obtained.

### SUMMARY OF THE INVENTION

In the present study, we carried out simultaneous depolymerization of PET and PC in one step with a simple separation of BPA and TPA and separated BPA and TPA (98 and 97% purity, respectively) in a single step, without any interference or secondary reactions detected. A composition of a PC-PET mixed stream (either separated polymers or polymer blends) was fully depolymerized in 2 min at 130° C. using 30 mL of KOH in methanol (KMH) solution per gram of polymer. This depolymerization system of present invention represents a groundbreaking development for industry that aims for higher efficiency of chemical recycling. We demonstrate that the simultaneous depolymerization of mixed waste streams is a real possibility to resolve the current problems of selective collection, targeting an all-in-one depolymerization system that can be applied worldwide, requiring low energy and inexpensive reagents.

In accordance with the purpose of the invention, as embodied and broadly described herein, the invention is broadly drawn to the use of an alcoholic medium, for instance methanol medium with an alkaline, for instance an alkali hydroxide, as depolymerization agent without any further addition of organic solvents under microwave action (heating) to achieve almost instantaneous, for instance within 1-15 minutes, for almost 100%, for instance 98-99, 9%, depolymerization of polyethylene terephthalate structures or polycarbonate structures of any suitable shape and morphology such as flakes, fibers, powder, sheet, pellet, spheres, pearls, dendrites, discs or any other three-dimensional shape with a micrometric or millimetric dimension, singly or in combination if these are millinized structures, microsized structures, structures having a thickness up to 5 mm or structures having a maximum dimension of not more than 10 mm.

In accordance with the purpose of the invention, as embodied and broadly described herein, the invention is broadly drawn to the use of an alcoholic medium, for instance methanol medium with an alkaline, for instance an alkali hydroxide, as depolymerization agent without any further addition of organic solvents under microwave action (heating) to achieve almost instantaneous, for instance within 1-13 minutes, for 100% or for almost 100%, for instance 98-99, 9%, depolymerization of polyethylene terephthalate structures or polycarbonate structures of any suitable shape and morphology such as flakes, fibers, powder, sheet, pellet, spheres, pearls, dendrites, discs or any other three-dimensional shape with a micrometric or millimetric dimension, singly or in combination if these are millinized structures, microsized structures, structures having a thickness up to 5 mm or structures having a maximum dimension of not more than 10 mm

In accordance with the purpose of the invention, as embodied and broadly described herein, the invention is broadly drawn to a method of depolymerization of mixture of single polymer structures or structures of different polymers by contacting the polymers with an alkali in alcohol medium and subjecting said mixture of different polymers and medium in a reaction chamber to microwave assisted heating.

In one aspect of the invention, the invention concerns a method for depolymerization of structures of a polymer by contacting the polymer with an alkali in alcohol medium and subjecting said mixture of polymer and medium in a reaction chamber to microwave assisted heating at temperatures ranging from 80-150° C. The reaction chamber is preferably closed, for instance the reaction chamber is during microwave assisted heating fluidly closed, for instance by a fluid-tight seal. Other reaction devices that avoid or limit pressure loss as a result of heating the reaction mixture, e.g. using a back pressure regulator in a continuous flow system, are also options to create an equivalent apparent pressure-closed reaction system. Such structures of a polymer are for instance obtainable by cutting, grinding, shredding or crushing polymer objects or polymer feedstock or a combination of these methods until such are formed into millinized structures, microsized structures, structures having a thickness up to 5 mm or structures having a maximum dimension of not more than 10 mm. These polymer structures may be of any suitable shape and morphology such as flakes, fibers, powder, sheet, pellet, spheres, pearls, dendrites, discs or any other three-dimensional shape with a micrometric or millimetric dimension, singly or in combination. Examples of polymers suitable for this method are for instance polymers of the group consisting of thermoplastic polyesters, for example poly(ethylene terephthalate), polycarbonate and polyamides. The reaction chamber is preferably closed, for instance reaction chamber is during microwave assisted heating fluidly closed, for instance by fluid-tight seal. Other reaction devices that avoid or limit pressure loss as a result of heating the reaction mixture, e.g. using a back pressure regulator in a continuous flow system, are also options to create an equivalent apparent pressure-closed reaction system.

In a practical embodiment, the method according to the present invention comprises depolymerization of a polyethylene terephthalate structures into terephthalic acid and ethylene glycol by contacting the polyethylene terephthalate with an alkali in alcohol medium and subjecting said polyethylene terephthalate medium mixture in a reaction chamber to microwave assisted heating. The method is used for depolymerization of polyethylene terephthalate structures into terephthalic acid and ethylene glycol at reaction temperature in the range of from 80° C. to 130° C. preferably from 90° C. to 130° C., yet more preferably from 110° C. to 130° C. For instance, this effect can be reached with polyethylene terephthalate structures with an average dimension of dimension of 1.5×10×10 mm average in a time frame from 1-13 minutes at temperatures ranging from 80-130° C. The method is also used for depolymerization of polyethylene terephthalate pieces, for instance flakes, fibers chunks, granules, slices, strips, crumbles, pellets, into terephthalic acid and ethylene glycol.

This invention accordingly provides the advantage that depolymerization of polyethylene terephthalate structures into terephthalic acid and ethylene glycol of polyethylene terephthalate flakes with micrometric or millimetric dimension, for instance polyethylene terephthalate flakes having an average thickness in the range of 1.1-1.9 mm, preferably 1-1.6 mm, is in a time frame from 1-13 minutes at temperatures ranging from 80-130° C.

This invention accordingly provides the advantage that depolymerization of polyethylene terephthalate structures into terephthalic acid and ethylene glycol of polyethylene terephthalate fibers or pellets with micrometric or millimetric dimension, for instance pellets having 3 mm radius and 5 mm length or fibers being 1 mm diameter average, is in a time frame from 2-13 minutes at temperatures ranging from 90-130° C.

In a practical embodiment, the method according to the present invention comprises depolymerization of a thermoplastic polyester, such as polyethylene terephthalate structures into terephthalic acid and ethylene glycol, by contacting the said polyester, e.g., polyethylene terephthalate, with an alkali in alcohol medium and subjecting said polyester, e.g., polyethylene terephthalate, medium mixture in a reaction chamber to microwave assisted heating. The method is used for depolymerization of thermoplastic polyesters, e.g., polyethylene terephthalate structures into terephthalic acid and ethylene glycol, at reaction temperature in the range of from 80° C. to 130° C. preferably from 90° C. to 130° C. yet more preferably from 110° C. to 130° C. For instance, this effect can be reached with polyethylene terephthalate structures with an average dimension of dimension of 1.5×10×10 mm average in a time frame from 1-13 minutes at temperatures ranging from 80-130° C. The method is also used for depolymerization of polyethylene terephthalate pieces, for instance flakes, fibers, chunks, granules, slices, strips, crumbles, pellets, into terephthalic acid and ethylene glycol.

In one aspect of the invention, the invention concerns method for depolymerization of polycarbonate structures by contacting the polycarbonate with an alkali in alcohol medium and subjecting said polycarbonate medium mixture in a reaction chamber to microwave assisted heating. The reaction chamber is preferably closed, for instance reaction chamber is during microwave assisted heating fluidly closed, for instance by fluid-tight seal. Other reaction devices that avoid or limit pressure loss as a result of heating the reaction mixture. e.g. using a back pressure regulator in a continuous flow system, are also options to create an equivalent apparent pressure-closed reaction system. The method is used for depolymerization of polycarbonate into bisphenol A and dimethyl carbonate at reaction temperature in the range of from 80° C. to 130° C. preferably from 100° C. to 130° C. yet more preferably 120° C. to 130° C. The method is also used for depolymerization of polycarbonate structures, for instance flakes, fibers chunks, granules, slices, strips, crumbles, pellets, into bisphenol A and dimethyl carbonate. A particular advantage of this method of present invention is that the reaction of depolymerization of polycarbonate flakes, fibers or pellets with micrometric or millimetric dimension is realized in a time frame in the range of 2-13 minutes at temperatures ranging from 90-130° C.

In a practical embodiment, the method according to the present invention comprises depolymerization of a polyamide structures, namely polyamide 6 or polyamide 6.6 into aminocaproic acid or hexamethylene diamine and adipic acid respectively by contacting the polyamide with an alkali in alcohol medium and subjecting said polyamide medium mixture in a reaction chamber to microwave assisted heating. The method is used for depolymerization of polyamide structures, with micrometric or millimetric dimension, into aminocaproic acid or hexamethylene diamine and adipic acid at reaction temperature in the range of from 80° C. to 150° C. preferably from 90° C. to 150° C. yet more preferably from 110° C. to 150° C. For instance, this effect can be reached with polyamide structures, with micrometric or millimetric dimension, for instance such structures with an average dimension of 1.5×10×10 mm, in a time frame from 1.5 to 3 hour at temperatures ranging from 130-150° C. The method is also used for depolymerization of polyamide structures of any suitable shape and morphology such as flakes, fibers chunks, granules, slices, strips, crumbles, pellets, into aminocaproic acid or hexamethylene diamine and adipic acid. A particular advantage of this method of present invention is that the reaction of depolymerization of polyamides fibers, pellets or powder, with micrometric or millimetric dimension, into aminocaproic acid or hexamethylene diamine and adipic acid is realized in less than 2 h at 150° C. or less.

Another aspect of the invention concerns a method for depolymerization of mixture of structures of different polymers by contacting the polymers with an alkali in alcohol medium and subjecting said mixture of different polymers and medium in a reaction chamber to microwave assisted heating at temperatures ranging from 80-150° C. The reaction chamber is preferably closed, for instance the reaction chamber is during microwave assisted heating fluidly closed, for instance by a fluid-tight seal. Such structures of polymers are for instance obtainable by cutting, grinding, shredding or object of different polymers or different polymer feedstock or a combination of these methods until such are formed into millinized structures, microsized structures, structures having thickness up to 5 mm or structures having a maximum dimension of not more than 20 mm, preferably not more than 10 mm and yet more preferably than 5 mm. These polymer structures may be of any suitable shape and morphology such as flakes, fibers, powder, sheet, pellet, spheres, pearls, dendrites, discs or any other three-dimensional shape with a micrometric or millimetric dimension, singly or in combination. The reaction chamber is preferably closed, for instance reaction chamber is during microwave assisted heating fluidly closed, for instance by fluid-tight seal. Other reaction devices that avoid or limit pressure loss as a result of heating the reaction mixture, e.g. using a back pressure regulator in a continuous flow system, are also options to create an equivalent apparent pressure-closed reaction system.

This method of the invention of depolymerization of mixture of structures of different polymers by contacting the polymers with an alkali in alcohol medium and subjecting said mixture of different polymers and medium in a reaction chamber to microwave assisted heating at temperatures ranging from 80-150° C. accordingly provides the advantage of simultaneous depolymerization of polyethylene terephthalate and polycarbonate in a single step, including the one-step separation of reaction products Bisphenol A and terephthalic acid.

This method of the invention of depolymerization of mixture of structures of different polymers by contacting the polymers with an alkali in alcohol medium and subjecting said mixture of different polymers and medium in a reaction chamber to microwave assisted heating accordingly provides the advantage of selective depolymerization of polyethylene terephthalate and polyamides in a heterogenous mixture or in a polymer blend in two steps, one at a temperature in a range of 110-130° C. for 2-5 minutes and a further one in a 140-160° C., preferably 145-155° C. for at least 1.5 h. The process renders terephthalic acid, and ethylene glycol in the first step and aminocaproic acid or hexamethylene diamine and adipic acid in the second stage.

This method of the invention of depolymerization of mixture of structures of different polymers by contacting the polymers with an alkali in alcohol medium and subjecting said mixture of different polymers and medium in a reaction chamber to microwave assisted heating accordingly provides the advantage of selective depolymerization of polycarbonate and polyamides in a heterogenous mixture or in a polymer blend in two stages, one at a temperature in a range of 110-130° C. for 2-5 minutes and a further one at 140-160° C., preferably 145-155° C., for at least 1.5 h. The process renders bisphenol and dimethyl carbonate in the first step and aminocaproic acid or hexamethylene diamine and adipic acid in the second stage.

This method of the invention of depolymerization of mixture of structures of different polymers by contacting the polymers with an alkali in alcohol medium and subjecting said mixture of different polymers and medium in a reaction chamber to microwave assisted heating accordingly provides the advantage of selective depolymerization of polycarbonate, polyethylene terephthalate and polyamides in a heterogenous mixture or in a polymer blend in two stages, one at a temperature in a range of 110-130° C. for 2-5 minutes and a further one at 140-160° C., preferably 145-155° C. for at least 1.5 h. The process renders bisphenol A, terephthalic acid and dimethyl carbonate in the first stage and aminocaproic acid or hexamethylene diamine and adipic acid in the second stage.

An alcoholic medium suitable for present invention can be methanol, ethanol, propanol and isopropanol.

Some statements of the invention are set forth in claim format directly below:
1) A method of depolymerizing polymer structures, the method comprising:
   a) providing a feedstock comprising polymer microstructures or polymers millistructures or cutting, grinding, shredding or crushing polymer objects or polymer feedstock or a combination of these methods until such are formed into structures with micrometric or millimetric dimension;
   b) providing an alkali in alcohol reaction mixture;
   c) subjecting the polymer structure in the alkali in alcohol reaction mixture to microwave assisted heating in a fluid-tight reaction chamber or any other reaction chamber that practically avoids or limits pressure loss as a result of heating the reaction mixture.
2) The method according to statement 1, whereby the structures have a thickness up to 5 mm or have a maximum dimension of not more than 10 mm.
3 The method according to any one of the statements 1-2, whereby the alkali is in an amount of between 7% and 14% by dry weight to provide a reaction mixture.
4) The method according to any one of the statements 1-3, whereby maintaining the reaction mixture with the polymer structures to a temperature of between 80° C. and 150° C.
5) The method according to any one of the statements 1-4, whereby the polymer structure is between 5% and 20% weight by volume of solution of alkali in alcohol.
6) The method according to any one of the statements 1-5, without any further addition of another organic solvents.
7) The method according to any one of the statements 1-6, for depolymerization of polyethylene terephthalate structures at temperatures ranging from 80-130° C. for up to 13 minutes into terephthalic acid and ethylene glycol.
8) The method according to any one of the statements 1-6, for depolymerization of polyethylene terephthalate structures into terephthalic acid and ethylene glycol in a time frame from 1-13 minutes at temperatures ranging from 80-130° C.
9) The method according to any one of the statements 1-6, for depolymerization of polycarbonate structures at temperatures ranging from 90-130° C. for up to 13 minutes into bisphenol A and dimethyl carbonate.
10) The method according to any one of the statements 1-6, for depolymerization of polycarbonate structures into bisphenol A and dimethyl carbonate in a time frame in the range of 2-13 minutes at temperatures ranging from 80-130° C.
11) The method according to any one of the statements 1-6, for depolymerization of polyamides structures at temperatures ranging from 140-160° C. for up to 2 hours into aminocaproic acid or hexamethylenediamine and adipic acid.
12) The method according to any one of the statements 1-6, for depolymerization of polyamides structures into aminocaproic acid or hexamethylenediamine and adipic acid, in a time, frame in the range of 1-2 hours at temperatures ranging from 140-160° C.
13) The method according to any one of the statements 1-6, for depolymerization of a mixture of polyethylene terephthalate and polycarbonate structures in a single step, including the one-step separation of reaction products bisphenol A and terephthalic acid.
14) The method according to any one of the statements 1-6, for selective depolymerization of mixture PET and polyamides structures in two steps into terephthalic acid and ethylene glycol in step 1) at 80-130° C. for 2-13 minutes and aminocaproic acid or hexamethylene diamine and adipic acid in step 2) at 145-155° C. for at least 1.5 h.
15) The method according to any one of the statements 1-6, for selective depolymerization of a mixture of polycarbonate and polyamides structures into bisphenol A, and dimethyl carbonate in step 1) at 80-130° C. for 2-13 minutes and aminocaproic acid or hexamethylenediamine and adipic acid in step 2) at 145-155° C. for at least 1.5 h.
16) The method according to any one of the statements 1-6, for selective depolymerization of mixtures polycarbonate, polyethylene terephthalate and polyamides structures in two steps, 1) at 80-130° C. for 2-13 minutes and 2) at 145-155° C. for at least 1.5 h whereby the method renders bisphenol A, terephthalic acid, ethylene glycol and dimethyl carbonate in the first step and aminocaproic acid or hexamethylene diamine and adipic acid in the second step.

Some statements of the invention are set forth in claim format directly below:
1) A method of depolymerizing polymer structures, the method comprising:
   a) providing a feedstock comprising polymer microstructures or polymers millistructures or cutting, grinding, shredding or crushing polymer objects or polymer feedstock or a combination of these methods until such are formed into structures with micrometric or millimetric dimension;
   b) providing an alkali in alcohol reaction mixture;
   c) subjecting the polymer structure in the alkali in alcohol reaction mixture to microwave assisted heating in a fluid-tight reaction chamber or any other reaction device that avoids or limits pressure loss as a result of heating the reaction mixture.
2) The method according to statement 1, whereby the structures have a thickness up to 5 mm or have a maximum dimension of not more than 10 mm.
3) The method according to any one of the statements 1 to 2, whereby the alkali is in an amount of between 1% and 30% by dry weight to provide a reaction mixture.
4) The method according to any one of the statements 1 to 2, whereby the alkali is in an amount of between 7% and 14% by dry weight to provide a reaction mixture.
5) The method according to any one of the statements 1 to 4, whereby the polymer structure is between 1% and 50% weight by volume of solution of alkali in alcohol.
6) The method according to any one of the statements 1 to 5, whereby the polymer structure is between 5% and 20% weight by volume of solution of alkali in alcohol.
7) The method according to any one of the statements 1 to 6, without any further addition of another organic solvents.
8) The method according to any one of the statements 1 to 7, whereby maintaining the reaction mixture with the polymer structures to a temperature of between 80° C. and 150° C.
9) The method according to any one of the statements 1 to 7, for depolymerization of thermoplastic polyester structures at temperatures ranging from 80 to 130° C. for up to 13 minutes into their polyester monomers.
10) The method according to any one of the statements 1 to 7, for depolymerization of poly ethylene terephthalate structures at temperatures ranging from 80 to 130° C. for up to 13 minutes into terephthalic acid and ethylene glycol.
11) The method according to any one of the statements 1 to 7, for depolymerization of thermoplastic polyester structures into their polyester monomers in a time frame from 1-13 minutes at temperatures ranging from 80 to 130° C.
12) The method according to any one of the statements 1 to 7, for depolymerization of poly ethylene terephthalate structures into terephthalic acid and ethylene glycol in a time frame from 1-13 minutes at temperatures ranging from 80-130° C.
13) The method according to any one of the statements 1 to 7, for depolymerization of polycarbonate structures at temperatures ranging from 90-130° C. for up to 13 minutes into their polycarbonate monomers.
14) The method according to any one of the statements 1 to 7, for depolymerization of polycarbonate structures into their polycarbonate monomers in a time frame in the range of 2-13 minutes at temperatures ranging from 80-130° C.
15) The method according to any one of the statements 1 to 7, for depolymerization of polyamides structures at temperatures ranging from 140-160° C. for up to 2 hours into their polyamide monomers.
16) The method according to any one of the statements 1 to 7, for depolymerization of polyamides structures into their polyamide monomers in a time, frame in the range of 1-2 hours at temperatures ranging from 140-160° C.
17) The method according to any one of the statements 1 to 7, for depolymerization of a mixture of thermoplastic polyester and polycarbonate structures in a single step, including the one-step separation of the obtained monomers.
18) The method according to any one of the statements 1 to 7, for selective depolymerization of mixture thermoplastic polyester and polyamides structures in two steps into the polyester monomers in step 1) at 80-130° C. for 2-13 minutes and polyamide monomers in step 2) at 145-155° C. for at least 1.5 h.
19) The method according to any one of the statements 1 to 7, for selective depolymerization of a mixture of polycarbonate and polyamides structures into polycarbonate monomers in step 1) at 80-130° C. for 2-13 minutes and polyamide monomers in step 2) at 145-155° C. for at least 1.5 h.
20) The method according to any one of the statements 1 to 7, for selective depolymerization of mixtures polycarbonate, thermoplastic polyester and polyamides structures in two steps, 1) at 80-130° C. for 2-13 minutes and 2) at 145-155° C. for at least 1.5 h whereby the method renders polyester and polycarbonate monomers in the first step and polyamide monomers in the second step.
21) The method according to any one of the statements 1 to 7, for depolymerization of a mixture of polyethylene terephthalate and polycarbonate structures in a single step, including the one-step separation of the obtained monomers.
22) The method according to any one of the statements 1 to 7, for selective depolymerization of mixture PET and polyamides structures in two steps into terephthalic acid and ethylene glycol in step 1) at 80-130° C. for 2-13 minutes and polyamide monomers in step 2) at 145-155° C. for at least 1.5 h.
23) The method according to any one of the statements 1 to 7, for selective depolymerization of a mixture of polycarbonate and polyamides structures into polycarbonate monomers in step 1) at 80-130° C. for 2-13 minutes and polyamide monomers in step 2) at 145-155° C. for at least 1.5 h.
24) The method according to any one of the statements 1 to 7, for selective depolymerization of mixtures polycarbonate, polyethylene terephthalate and polyamides structures in two steps, 1) at 80-130° C. for 2-13 minutes and 2) at 145-155° C. for at least 1.5 h whereby the method renders polyethylene terephthalate and polycarbonate monomers in the first step and polyamide monomers in the second step.
25) The method according to any one of the statements 1 to 7, for depolymerization of a mixture of polyethylene terephthalate and polycarbonate structures in a single step, including the one-step separation of reaction products bisphenol A and terephthalic acid.
26) The method according to any one of the statements 1 to 7, for selective depolymerization of mixture PET and polyamides structures in two steps into terephthalic acid and ethylene glycol in step 1) at 80 to 130° C. for 2 to 13 minutes and aminocaproic acid or hexamethylene diamine and adipic acid in step 2) at 145-155° C. for at least 1.5 h.
27) The method according to any one of the statements 1 to 7, for selective depolymerization of a mixture of polycarbonate and polyamides structures into bisphenol A, and dimethyl carbonate in step 1) at 80 to 130° C. for 2 to 13 minutes and aminocaproic acid or hexamethylenediamine and adipic acid in step 2) at 145 to 155° C. for at least 1.5 h.
28) The method according to any one of the statements 1 to 7, for selective depolymerization of mixtures polycarbonate, polyethylene terephthalate and polyamides structures in two steps, 1) at 80 to 130° C. for 2 to 13 minutes and 2) at 145 to 155° C. for at least 1.5 h whereby the method renders bisphenol A, terephthalic acid, ethylene glycol and dimethyl carbonate in the first step and aminocaproic acid or hexamethylene diamine and adipic acid in the second step.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### DETAILED DESCRIPTION OF EMBODIMENTS OF THE INVENTION

The following detailed description does not limit the invention. Instead, the scope of the invention is defined by the appended claims and equivalents thereof.

### Definition

Nanosized in the meaning of this application is having dimensions of only a few nanometers; Microsized in the meaning of this application is having dimensions of only a few and micrometers and millisized in the meaning of this application is having dimensions of only a few millimetres.

“nano-” structures refer to structures having diameters or smallest dimensions of less than 1 micron. “micro-” structures refer to structures having diameters or smallest dimensions of less than 1 millimeter. milli-“structures refer to structures having diameters or smallest dimensions of less than 1 centimeter.

Suitable alkali hydroxides for the method of present invention are alkali hydroxide of the group consisting of lithium hydroxide (LiOH), sodium hydroxide (NaOH), potassium hydroxide (KOH), rubidium hydroxide (RbOH), cesium hydroxide (CsOH), calcium hydroxide (Ca(OH)₂) and magnesium hydroxide (Mg(OH)2). PET as used herein is the abbreviation for polyethylene terephthalate.

PC as used herein is the abbreviation for polycarbonate.

Polyethylene terephthalate (PET) and polycarbonate (PC) are widespread commodity polymers found in a wide variety of applications, such as food and beverage packaging, safety goggles, car windshields, tubing, and fabrics, among many others. According to plasticseurope.org, the global production of plastics is still increasing at a rate of around 10 MTon per year. This growth is due to the versatility of plastics as inexpensive substitutes for other materials in a broad range of fields, from electronics to biomedicine.

Mixed plastic waste-streams are a main obstacle in the art to a more extensive implementation of polymer recycling. Separating mixed-plastic waste streams demands time and effort at collection or in the recycling plant, while many products consist of or comprise multiple polymers that cannot be readily separated. Chemical recycling could provide the key to overcome this issue by targeting specific chemical bonds, enabling selective depolymerization of a single polymer class in a mixture. Present invention concerns depolymerization of polycarbonate (PC) and polyester (PE) such as poly-ethylene terephthalate (PET) in separate and in mixed streams. Selective depolymerization of mixed streams composed of PET and PC and one-step separation of their constituent monomers are carried out with outstanding energy efficiency through an inexpensive KOH-in-methanol hydrolysis (KMH) process developed for instantaneous PET hydrolysis.

As demonstrated, the activation energies for depolymerization of PC and PET pellets can be 68.6 and 131.4 KJmol⁻¹, respectively. In such case randomly mixed streams were fully depolymerized within 2 min at 120° C. using 30 mL of depolymerization solution per gram of polymer. The separation of bisphenol A and terephthalic acid is demonstrated in a one-step separation process, yielding 98 and 97% purity without any secondary reactions detected. Simultaneous depolymerization and selective one-step separation of monomers are also demonstrated for a PET/PC polymer blend prepared by solution casting, showing that this process also works for intimately mixed PET/PC mixtures.

### EXAMPLES

### Example 1 Materials

Methanol (>99.9%) was provided by Fischer Scientific. Transparent PET pellets were extruded from recycled PET, used with and without thermal annealing. Transparent PC pellets were obtained from Sigma Aldrich and used as received. Potassium and sodium hydroxide were provided by VWR chemicals (89.3%). High-pressure vials for the microwave reactor were provided by Biotech. Tight seal lids were provided by Fischer Scientific.

### Example 2 Characterization

2a FTIR spectroscopy: FTIR analyses were performed on an Alpha 1 spectrophotometer (Bruker) operated in Attenuated Total Reflection mode with single reflection on unreacted polymers and depolymerization products combining 24 scans between wavenumbers 450 and 4000 cm−1.

2b Thermogravimetric analysis (TGA): TGA was performed on a Netzsch Tarsus TG209F3 using platinum pans for the polymers and alumina pans for the depolymerization products. The apparatus was equipped with a differential thermal accessory for determination of thermal transitions. Amounts ranging from 5-10 mg were loaded in the pans and the analyses were carried out using air as carrier gas and nitrogen as protective flow gas for the microbalance. A heating rate of 10° C. min 1 was used from 30 to 900° C.

2c Differential scanning calorimetry (DSC): DSC analyses were carried on a DSCQ2000 (TA instruments) using aluminum Tzero pans. The polymer analysis consisted in heating from room temperature to 280 C. keeping the sample isothermal for 5 min followed by rapid quenching to −60 C, aiming to amplify the signal for the amorphous region and to promote cold crystallization. After stabilization at 60 C, the sample was heated at 5 Cmin−1 to 280 C, to determine the glass transition temperature (Tg), cold crystallization temperature (Tcc), melting temper-ature (Tm) and enthalpies of crystallization and melting (ΔHcc and ΔHm). For the analysis of the depolymerization product, a single heating cycle from room temperature to 280 C at 5 Cmin−1 was applied.

2d Wide-angle X-ray scattering (WAXS): WAXS analyses were carried out using a Xenocs Xeuss 2.0 laboratory beamline (Xenocs, Sassenage, France) equipped with a CuKα ultralow dispersion X-ray source (acceleration voltage 50 kV with a current of 0.6 mA) and a DECTRIS Eiger 1 M detector in virtual detector mode. The sample (a slice of pellet of around 200 microns) was held under vacuum between two pieces of Kapton and the scattering patterns were collected in transmission mode with an exposure time of 600 s. LaB6 was used to calibrate the setup, and the empty Kapton holder was measured as background.

2e 1H NMR spectroscopy: The 1H NMR spectroscopy analyses were carried on a Spinsolve 60 Ultra (Magritek) benchtop NMR spectrometer. The analyses were carried out on products at a concentration of 20 mg·mL⁻¹ in deuterated DMSO as solvent for the PET depolymerization product and chloroform for the PC depolymerization product.

2f Calculation of green metrics: The E factor is based on the environmental factor (E), proposed by Sheldon in 1992,[21] which has been used in green chemistry metrics with success and corresponds to a simple mathematical relation of the amount of waste generated per unit product. Equations (1)-(3) in FIG. 13, giving energy efficiency (ε), environmental factor (E) and environ-mental energy impact x), respectively, were used to assess the efficiency of the processes. [E. Barnard, et al Green Chem. 2021, 23, 3765-3789]. Herein, we pay special attention to the x coefficient as a combination of energy economy coefficient and E factor, that is to say, the relative amount of energy consumed for the production of a certain amount of product. In Equation (1), T is the temperature of the depolymerization process and t is the time necessary to achieve the value of the yield (Y). The 0.1 multiplier agrees with the definition of the E factor where it was established that 10% of the solvent employed in an industrial process is not recovered, therefore, it is included in the amount of waste produced.

2g Estimation of activation energy of depolymerization processes: The activation energy for the depolymerization reaction of annealed PET and PC pellets was estimated by plotting the inverse of the concentration (mol L−1) of PET-mers in the reaction system (a mer is the repeating unit inside the polymer chain) as a function of reaction time (first order reaction) and the concentration (mol L−1) of PC-mers (zero order reaction) as a function of reaction time. For the zero-order reaction, the kinetic equation that describes the reaction rate is given by Equation (4) and for the first order reaction, the kinetic equation that describes the reaction rate as a function of concentration of species is given by Equation (5). Working at four different temperatures (70, 80, 90, and 100 C for PET; 50, 60, 70, and 80 C for PC), four different slopes (reaction rates) were obtained. The apparent activation energies for the depolymerization of PET and PC pellets, using the developed KMH system, can be estimated by applying the Arrhenius equation [Eqs. (6) and (7) in FIG. 13]

### Example 3

It was demonstrated that a methanol medium with an alkali hydroxide can be used as depolymerization agent without any further addition of another organic solvents under microwave assisted heating to achieve almost instantaneous, for instance within 1-13 minutes at temperatures above the boiling point of methanol, for instance, temperatures in the range of 80 to 130° C., for almost 100%, for instance 98-99.99%, depolymerization of polyethylene terephthalate structures pellets and/or flakes with micrometric or millimetric dimension or of polycarbonate pellets with micrometric or millimetric dimension.

### Example 4

It was demonstrated that microwave radiation increases the effective collisions among liquid and solid phase, favored by the increased shrinking-layer caused by the organophilic nature of the methanol-alkali solution. As a result, the depolymerization is extremely fast compared, in a matter of a few minutes, for instance in a time frame from 1-13 minutes at temperatures ranging from 80-130° C., to previous works of the state of the art using microwaves for PET and PC structures with micrometric or millimetric dimension.

### Example 5

It was demonstrated that use of pressure sealed vessels builds up a high internal pressure, responsible for the highly efficient depolymerization results. As an example of the effect of pressure it can be considered the kinetics of PET and PC. While polycarbonate is normally more difficult to depolymerize at atmospheric pressure than PET, using microwaves heating in the temperature range of 110° C.-130° C., in sealed reaction flasks cause the depolymerization to go faster for PC than for equivalent size pellets of PET. The methanol medium with an alkali hydroxide can be used as depolymerization agent without any further addition of another organic solvents under microwave assisted heating. The use of pressure sealed vessels builds up a high internal pressure, allowed us to carry out a one-step simultaneous depolymerization and selective one-step purification of bisphenol-A (“BPA”) and terephthalate (“TP”) mixtures (and secondary monomers such as ethylene glycol and dimethyl carbonate). Once the reaction time is over, at least 100% excess water with respect to the volume of alcoholic alkali is added. The homogeneous reaction mixture is neutralized with inorganic acid (from which hydrochloric acid proved to be the most convenient), producing a white solid, terephthalic acid which is washed with water and dried, and a liquid fraction distilled under reduced pressure at temperature in the range of 50-60° C. and pressure in the range of 200-300 mBar for less than 20 min. The evaporation of methanol and dimethyl carbonate under these conditions produces the selective precipitation of Bisphenol A, which is filtered and washed. Based on the different solubility of both products, BPA and TP were successfully separated from the homogeneous reaction mixture obtained after 100% or almost 100%, for instance 98-99, 99% depolymerization of PET and PC. The filtered liquid can be distilled to separate the remaining depolymerization products.

### Example 6

Microwave assisted heating allowed us to perform selective depolymerization and purification of depolymerization products using the methanolic alkali to successfully depolymerize complex waste streams containing polyethylene terephthalate, polycarbonate and polyamides. The multiple depolymerization process comprises the treatment of heterogeneous waste stream of polymers, for instance mixtures of PET and PC structures under the conditions mentioned in Example 3. After the reaction period, water is added to the heterogeneous mixture as mentioned in Example 3, then it is filtered and the liquid phase undergoes the same purification steps mentioned in Example 3 to realize separation and purification of Bisphenol A. Terephthalic acid, ethylene glycol and dimethyl carbonate. The filtered insoluble product separated after first step is submitted to 140-160° C., preferably 145-155° C., yet more preferably 149-151° C., by microwave heating in a pressurized reaction vessel with methanolic alkali solution in the ratio 10 ml:0.5 g to polymer. After the specified reaction time the obtained homogeneous mixture is neutralized with inorganic acid (from which hydrochloric acid proved to be the more convenient) and further submitted to distillation under reduced pressure. The aminocaproic acid can be recovered as the only product of the polyamide6 depolymerization process, while polyamide 6,6 renders hexamethylene diamine and adipic acid. It was found that this method can also be applied to depolymerize quaternary waste streams containing PET, PC and Polyamide 6 (PA6), as well as polyolefins, included, but not limited to the polyolefins of the group consisting of polyethylene (PE), polypropylene (PP), high-density polyethylene (HDPE), ultra-high-molecular-weight polyethylene (UHMWPE, UHMW), low-density polyethylene (LDPE), poly(vinylidene fluoride) (PVDF), polytetrafluoroethylene (PTFE) and polystyrene (PS). By applying this method PET, PC and PA6 can be successfully depolymerized, leading to monomers and clean unreacted polyolefins that are ready for further depolymerization processes, either by pyrolysis or any other chemical process, or even physical recycling methods.

An inexpensive KOH-in-methanol hydrolysis (KMH) process was found to depolymerize Polycarbonate and PET in low amounts of time (1 to 5 min) at mild temperatures (from 90 to 130° C.). For the depolymerization of polyamides, the KMH is a significantly weaker depolymerization agent, presenting little to no depolymerization in short times. Temperatures in the order of 150 and 1.5 h proved to be enough to fully depolymerize polyamide 6 into aminocaproic acid. The FIG. 12 summarizes the polymer conversions as a function of time for 4 different temperatures.

### Example 7 Depolymerization of PET Pellets

In a typical experiment (with exemptions specified where occur-ring), 0.5 g of PET pellets were charged into a high-pressure vial with 10 mL of a 1.25 m KOH solution in methanol (from now on referred to as KMH solution). The vials were closed with hermetically sealed metallic lids and placed into a microwave reactor (Initiator+Microwave System, Biotage, Sweden). The microwaves reactor takes typically 45 to 60 s to reach the desired temperature. Furthermore, it keeps the system temperature at 5° C. of the programmed value, reason for which, the reaction time was taken.

to start when the system reached 5° C. below the programmed temperature (several reaction temperatures were studied). The system was stirred magnetically at 600 rpm. After the specified reaction time, 10 mL of distilled water was added. The insoluble unreacted PET was filtered off, washed with distilled water (200 mL), dried under vacuum at 80° C., and weighed. The filtered solution was neutralized with concentrated hydrochloric acid, producing a white precipitate. Acid addition was stopped around pH 4. The white solid was filtered off, washed with distilled water (200 mL) and methanol (100 mL), dried under vacuum, and weighed.

### Example 8 Depolymerization of PC Pellets

Approximately 0.5 g of PC pellets were charged into a high-pressure vial along with 10 mL of the KMH solution. The vials were closed with hermetically sealed metallic lids and placed into a microwave reactor (Initiator+Microwave System, Biotage, Sweden). The reaction time was taken to start when the system reached 5° C. below the programmed temperature (several reaction temperatures were studied). The system was stirred magnetically at 600 rpm. After the reaction time, 10 mL of distilled water was added. The insoluble unreacted PC was filtered off, washed with methanol (50 mL) and distilled water (200 mL), dried under vacuum at 80° C., and weighed. The filtered solution had a reddish color and was neutralized with concentrated hydrochloric acid. Acid addition was stopped at approximately pH 4 (the depolymerization product serves as acid/base indicator, since the solution goes from reddish to colorless). The homogeneous neutralized solution was placed on a rotary evaporator and a single distillation step was applied; 200 mBar at 50° C. Upon full evaporation of methanol, BPA monomer precipitated out. The flask containing the white solid was left for 1 h at room temperature, allowing crystallization of BPA, which was subsequently filtered, washed with distilled water (3×), dried under vacuum, and weighed.

### Example 9 Preparation of PET/PC Blend

Approximately 1 g of PC pellets and 1 g of PET pellets were dissolved overnight in 10 mL hexafluoroisopropanol (HFIP) at room temperature. The polymer solutions were mixed and left under stirring for at least 1 day. The mixed solution was poured in a leveled Teflon dish and left overnight inside a fume hood to allow solvent evaporation. Lastly, the Teflon dish was submitted to vacuum at 60° C. overnight and the polymer blend was cut and used in subsequent depolymerization experiments.

### Example 8 Depolymerization of PET/PC Waste Streams and PET/PC Blend

In a general experiment (exemptions indicated where occurring), a mass of approximately 0.5 g of different proportions of mixed PC/PET pellets and/or 0.5 g of PET/PC 1:1 blend was charged into a high-pressure vial along with 10 mL of KMH solution in an analogous process to the ones presented in 2.2.1 and 2.2.2. The depolymerization and one-step separation of BPA and TPA are shown in FIG. 11.

Concerning the depolymerization of polyethylene terephthalate pellets by microwave-assisted reactions we observed that the increase in particle thickness demanded higher energy for reaction completion. PET pellets required a slight increase in reaction temperature, time, or KMH/PET ratio, as further presented herein. In FIG. 1 (A), the PET conversion as a function of temperature is depicted for annealed and unannealed PET pellets. There is an influence of the annealing pre-treatment on the behavior of the depolymerization reaction at different temperatures. Whereas, the annealed pellets are less accessible to the depolymerization reaction at lower temperatures, owing to higher crystallinity, which is proven by the WAXS patterns in FIG. 1 (B), the polymer conversion became higher for the annealed pellets compared to the unannealed as the temperature increased, to such an extent that the annealed pellets were fully depolymerized at 130° C. On the other hand, for unannealed PET pellets the conversion did not stabilize between 80 and 130° C. This irregular pattern could be attributed to the use of the energy from the depolymerization system for conformational changes (thermal transitions) before the depolymerization reaction, which delays the process. Thus, owing to these findings, the annealed PET pellets were used for the kinetic experiments.

Depolymerization of polycarbonate pellets: There was no relevant information with respect to the action of the KMH system on polycarbonate. However, since polycarbonate is a worldwide common plastic waste, there is a need in the art for an efficient depolymerization. The polycarbonate depolymerization process was studied and compared to the PET KMH depolymerization process. Owing to the amorphous nature of PC, we studied its behavior. It behaved differently to PET, verified through direct comparison of polymer conversions at 90° C. for different reaction times (FIG. 2; note that in this particular experiment, PET pellets were unannealed, hence, amorphous). PET depolymerization started at a lower temperature, as shown by the higher polymer conversion at 1 min, which can be explained by the higher stability of the carbonate bond compared to the ester bond of PET. Nevertheless, it should be noted that PC conversion increased with temperature at a different rate than it did for unannealed PET pellets. At 90° C. PET has already reached the glass transition temperature, while PC is still far from that thermal transition, implying the possible formation of crystallites inside PET pellets during reaction (as discussed in the previous section). These organized regions in PET leave less space for KOH to attack and cleave the ester bond. Consequently, the increase in reaction time produced a different effect on the PC depolymerization rate than on the PET depolymerization rate. The reaction of PET pellets during 1 min at 120° C. did not lead to full polymer conversion, whilst PC was full converted under the same conditions.

Kinetics of PC and PET depolymerization reactions: PC depolymerization kinetics are shown in FIG. 3. The depolymerization process follows zero-order kinetics, given the constant decrease in concentration of PC-mer with reaction time. According to the Arrhenius plot (FIG. 3, B), the activation energy for this depolymerization process is 68.6 kJmol−1, significantly lower than the values commonly found for PET [C. Y. Kao, W. H. Cheng, B. Z. Wan, J. Appl. Polym. Sci. 1998, 70, 1939-1945]. The depolymerization kinetics can be explained by the amorphous nature of the polymer, which provides easier access to the carbonate bonds, consequently favoring the ratio of effective collisions. Consequently, the reaction is accelerated by an Increase in pressure and temperature, such that 120° C. and 1 min in the microwave fully depolymerized PC pellets (1.25 m KMH solution, 0.5 g polymer to 10 mL solution).

In contrast, PET depolymerization kinetics (FIG. 4) follows a second order kinetics rate law, where the inverse of concentration of PETmer as a function of reaction time was linear. By plotting the angular coefficient as a function of the reciprocal temperature in Kelvin (FIG. 4, B), the activation energy of the depolymerization process was estimated as 131.4 KJmol−1. This activation energy is significantly higher than the activation energy determined for PC, which is most likely due to the difference in their crystalline nature. Whereas, PET is a semicrystalline polymer, PC is completely amorphous and does not undergo any thermal transitions as postulated with PET during the reaction process.

Simultaneous depolymerization of PET and PC mixed streams: Although there is a clear difference in the kinetics of the two studied polymers for depolymerization by KMH solution under microwave heating, they share an important feature: They depolymerize under similar conditions. This led to the question: is it possible to simultaneously depolymerize a mixed waste stream containing both PC and PET. There are a few studies in which the selective depolymerization by glycolysis was performed on PC and PET.[[E. Barnard, et al Green Chem. 2021, 23, 3765-3789] In such study, polycarbonate was depolymerized at lower temperatures, leaving PET almost intact. This implies two steps for the depolymerization of a mixed PC-PET stream, increasing the costs for an industrial process. As mentioned earlier in this application, the KMH system developed by our group possesses several competitive advantages, reflected in significantly better green chemistry metrics.[E. Barnard, et al Green Chem. 2021, 23, 3765-3789].

The present invention optimized was the time and temperature required to fully depolymerize a mixed stream comprising PET and PC, regardless of the blend composition. For that, PET was the limiting feedstock, owing to its higher activation energy. Depolymerization of annealed PET pellets showed 100% conversion when performed in 1 min at 130 C. First attempts involved the simultaneous depolymerization of a 1:1 mass ratio mixed stream, which served to demonstrate the feasibility of the proposed method. After the specified reaction time, a white cloudy reaction mixture was obtained, which became transparent upon water addition. Neutralization of the reaction medium caused precipitation of terephthalic acid (soluble at alkaline pH as potassium terephthalate). For this process, we verified that HCl was more desirable to carry out the neutralization than sulfuric acid, owing to a cloudiness that hinders the further precipitation of BPA when sulfuric acid was used. Once the pH was further reduced to 4, the white solid that forms was filtered off, washed 3× with distilled water and 3× with ethanol. The produced solid was verified to be 97% pure TPA by peak integration of 1H NMR spectrograms (FIG. 5). The NMR spectrum presented a broad peak around 13 ppm corresponding to the O—H of the acid and a peak around 8 ppm corresponding to the hydrogens attached to the aromatic ring.

FTIR spectroscopy (FIG. 6) serves to demonstrate the identity and purity of the obtained solid. The FTIR spectra agrees with reported values for TPA,[11] showing as a main feature the carbonyl band at 1673 cm⁻¹, which corresponds to the carbonyl bond of esters.

Differential scanning calorimetry (DSC) of the solid (FIG. 7, B) did not show any melting or crystallization peak. Pure terephthalic acid does not show any thermal transition in the studied range, which serves as indirect evidence of the identity of the produced solid as TPA.

The filtered liquid fraction was neutralized through addition of KMH solution. Further, it was submitted to rotary evaporation at reduced pressure (200 mBar) and 65 C to slowly remove the methanol from the reaction mixture. Once methanol was removed, BPA crystals started to appear in the flask, as shown in the inset image (FIG. 5). Once all the methanol was evaporated, the pressure was reduced further down to 150 mBar to ensure full precipitation of BPA. The formed solid was filtered off, washed with distilled water, and dried under vacuum. The NMR characterization performed using deuterated DMSO as solvent (FIG. 5) presents the expected three sets of peaks: the O—H protons appear at the highest chemical shift (12.7 ppm), the eight aromatic protons appear as multiplets at around 6.6 ppm (due to the symmetry of the molecule), and the protons belonging to the two methyl groups appear at around 1.4 ppm. FTIR spectra (FIG. 6) shows as a main feature the absence of a carbonyl band, which rules out the presence of remaining TPA in significant amounts, corroborating the determination of 98% pure BPA through NMR peak area calculations. The FTIR spectrum coincided exactly with the one obtained for commercial BPA. DSC of the depolymerization product serves to confirm the identity of the depolymerization product (FIG. 7). A sharp endothermic peak appeared at 158.5° C., which agrees with the melting temperature of pure BPA. The remaining liquid could be further distilled to obtain ethylene glycol.

The major concern for the simultaneous depolymerization of PET and PC is that the formed products may react to form mixed oligomers during the process, however, the formation of the two clearly identified monomers guarantees that (at least for short periods in the studied range of temperatures) micro-wave irradiation did not induce repolymerization of the formed monomers. This represents a breakthrough in the development of new expanded systems that can comprise a high number of polymers to be chemically depolymerized simultaneously and selectively.

Optimization of simultaneous depolymerization conditions: Aiming to find the optimal polymer/solution ratio, the yield as a function of reaction mixture composition yield was studied (FIG. 8). The optimal reaction time for the system (ratio of polymer to solution 0.5 g:10 mL in a 10 mL total volume and 1:1 PET/PC mass ratio) was found to be 2 min. Beyond that time, the system had already completed full depolymerization of both polymers, making longer reaction times unnecessary. We can infer that the extension of reaction time beyond the minimum necessary time does not have negative effects on the formation of products, which implies that in a multi-component stream depolymerization at this temperature (120° C.) could be performed for longer times if needed. Finding the optimal polymer to solution ratio and total volume in terms of highest energy efficiency is important in the search of diminishing the E factor of the proposed strategy. FIG. 8 (B) shows the results obtained from varying the polymer to solution ratio and total volume in a MW vial. We attempted to prove that monomer yield could be improved when we worked with a higher amount of material. A clear trend was observed in which doubling the amount of polymer (i.e., upscaling the process) resulted in a significant increase in monomer yield. It is therefore expected that close to 100% yield can be obtained in a large-scale reactor setup. Increasing the ratio of polymer to solution did not have a positive effect on the reaction, presenting a slight reduction in the PET conversion. Owing to this, it is safe to say that 0.5 g of polymer to 10 mL of solution behaved well under the conditions studied for these experiments.

To verify the flexibility of our proposed system to fully depolymerize real-life mixed PET-PC mixtures, randomly composed mixtures were submitted to depolymerization. In FIG. 9, the PC and PET conversions are plotted as a function of the PC and PET ratios in the mixed stream. When most of the mixture is composed of PC, conversion is 100% and this stayed the same up to a 1:1 mixture. However, when a slightly higher proportion of PET was fed into the system the PET conversion decreased, becoming more pronounced at higher proportions of PET. This indicates that for a preferred simultaneous system, regardless of the composition of the mixture, reaction conditions require change. We explored increasing the reaction time to 3 min, reaction temperature to 130° C., and changing the ratio of KMH solution to polymer from 10 mL:0.5 g to 15 mL:0.5 g. The change in KMH/polymer ratio was most efficient, always showing 100% PET/PC conversion. As a result, we can affirm that a system containing a random composition of PET/PC can be fully depolymerized by microwaves in scaled reaction units at 120° C. using 30 mL of KMH solution per g of polymer, and its components can efficiently be separated without varying the amounts of reagents or doing any major modifications to the procedure.

Effective depolymerization of a PET/PC polymer blend: Considering the intimate mix between polymers in a blend, the accessibility of the KMH solution to different phases in a polymer blend can also be assessed. Thus, a blend of PET/PC (1:1 mass ratio) was prepared as described in the experimental section. FIG. 10 (A) depicts the DSC analysis (second melting process after quenching) where two Tg values are detected at different values than the ones observed for the isolated pure polymers, which demonstrate that the blend are intimately mixed. All of the reaction times studied (1.25 m KMH and 0.5 g:10 mL) showed full conversion (FIG. 10, B), demonstrating that not only elements of PC and PET can be introduced in a upscaled recycling plant, but also polymer blends are suitable for depolymerization, regardless of how intimately mixed they are. Since the polymer market is so varied and blends are part of the plastic waste stream, guaranteeing that mixed blends are also depolymerized, offers more possibilities for the KMH system to be expanded to more complex mixtures.

It will be apparent to those skilled in the art that various modifications and variations can be made in method of depolymerization of polymer structure of the presented dimensions and in an alkali in alcohol medium using a reaction chamber or vessel that is sealed to build up pressure during reaction under microwave assisted heating of the present invention and in construction of the system and method without departing from the scope or spirit of the invention. Examples of such modifications have been previously provided.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### BRIEF DESCRIPTION OF THE DRAWINGS

FIG. 1A displays: PET conversion as a function of temperature for annealed and unannealed PET pellets. The reactions were performed under the same conditions (1 min reaction time, 1.25 m KMH solution, 0.5 g PET in 10 mL KMH solution, microwaves in tight-sealed vials) varying exclusively temperature and pre-treatment of the pellets.

FIG. 1B displays: WAXS profile for annealed and unannealed PET pellets, evidencing the effect of annealing on crystallinity by showing the presence of PET diffraction peaks.

FIG. 2 is a graphic that shows a comparison of depolymerization of PET and PC pellets at 90° C.

FIGS. 3A and 3B are graphic displays that show the depolymerization kinetics for reactions performed in microwave reactor over 0.5 g of PC pellets. FIG. 3A: Concentration of PC-mer as a function of reaction time for depolymerization processes carried out at 50, 60, 70 and 80 C. FIG. 3B: Arrhenius plot for determination of activation energy for the depolymerization using KMH (1.25 m) solution over polycarbonate pellets.

FIGS. 4A and 4B are graphic displays that show the depolymerization kinetics for reactions performed in microwave reactor over 0.5 g of annealed PET pellets. FIG. 4A: Reciprocal concentration of PET-mer as a function of reaction time for depolymerization processes carried out at 70, 80, 90 and 100 C. FIG. 4B: Arrhenius plot for the determination of activation energy for the depolymerization of annealed PET pellets using KMH (1.25 m) solution.

FIGS. 5A and 5B are graphic displays that show NMR spectra of the solid products obtained from simultaneous KMH depolymerization of PET (FIG. 5A) and PC (FIG. 5B). The integration values (impurities surrounded by the boundaries of a square) are displayed under the spectrum and the chemical shifts on top. Analysis of integrated area below peaks of product and impurities leads to estimated purity of 97 and 98% for TPA and BPA respectively.

FIG. 6 is a graphic display that shows a FTIR spectra of depolymerization products from PET and PC.

FIGS. 7A and 7B are graphic displays that show FIG. 7A: DSC of the polycarbonate and PET pellets. FIG. 7B: DSC of depolymerization product of polycarbonate and PET.

FIGS. 8A and 8B are graphic displays that show FIG. 8A: Optimization of reaction time for reactions performed at 120° C. using a system in which the ratio of polymer to solution was kept at 0.5 g:10 mL in a 10 mL total volume and 1:1 PET/PC mass ratio and 1.25 m KMH solution. FIG. 8B: Optimization of polymer/KMH solution mass ratios and total volume for systems reacted at 120 C for 2 min in a microwave reactor using KMH solution (1.25 m).

FIG. 9 is a graphic display that shows a PET and PC conversions as a function of mass fractions of PET and PC in the mixed stream for a depolymerization in MW reactor using sealed vials. Polymer/KMH solution ratio=0.5 g:10 mL, 1.25 m KMH, 120 C.

FIGS. 10A and 10B are graphic displays that show FIG. 10A: DSC of the solution-casted PET/PC blend (1:1). FIG. 10B: PET conversion, PC conversion, TPA yield, and BPA yield as a function of reaction time for the PET/PC blend.

FIG. 11 is a graphic flow chart that shows simultaneous depolymerization of PET/PC mixed waste streams and one-step separation of constituent monomers.

FIG. 12 displays the polymer conversion as a function of time for Polyamide 6 depolymerization reactions performed at 120, 130, 140 and 150 C using the KMH solution. The reactions were performed in high pressure vials using microwaves reactors. The Polyamide 6 were provided by Sigma Aldrich in the form of pellets of about 0.8 mm diameter.

FIG. 13 shows equations associated with the calculation of green metrics and the estimate of activation energy of depolymerization processes.

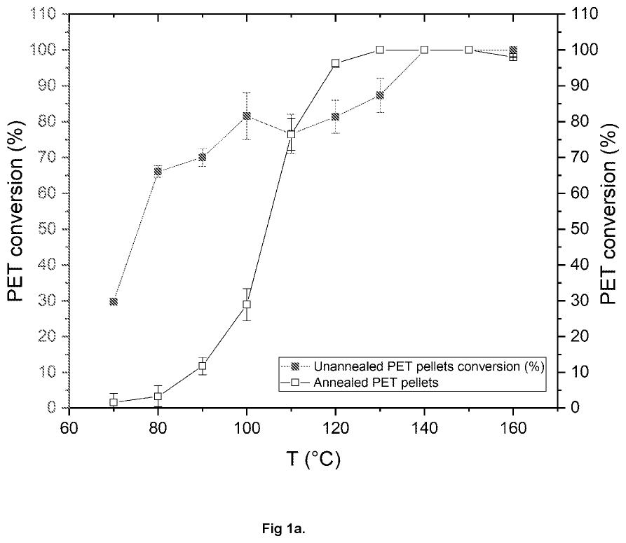

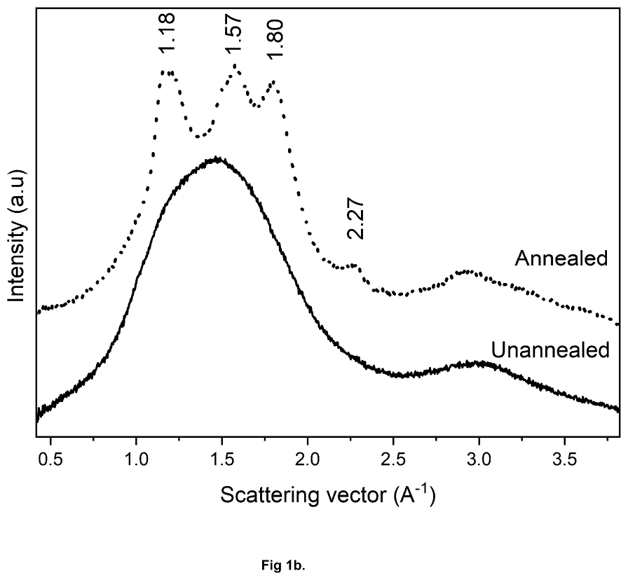

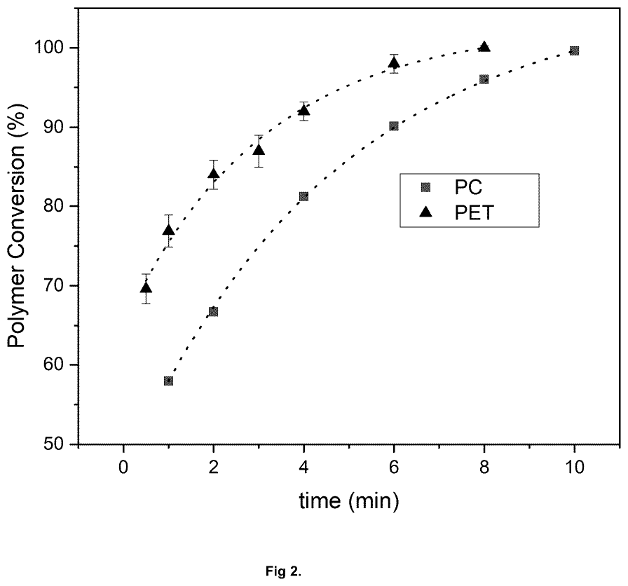

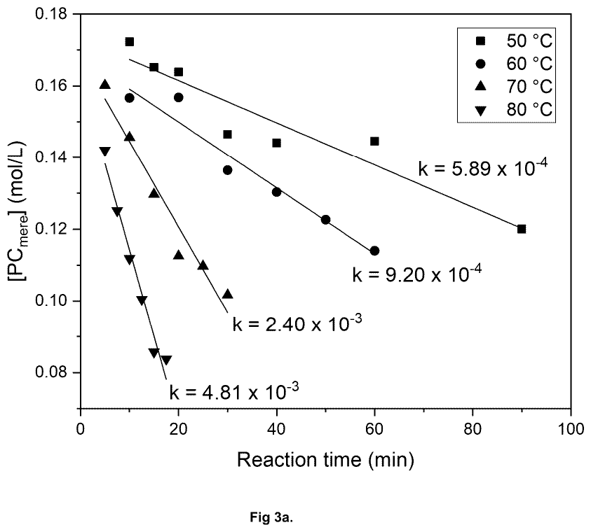

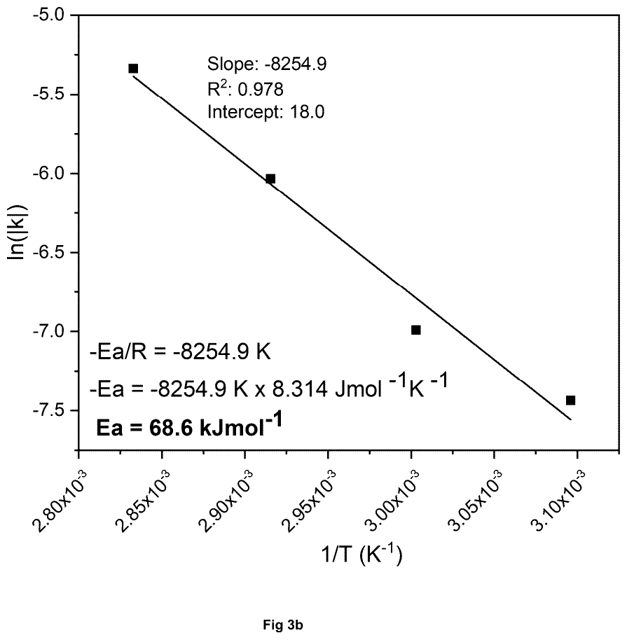

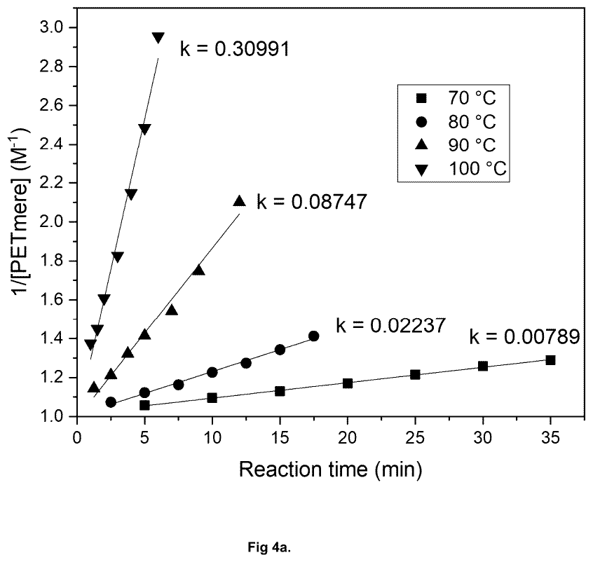

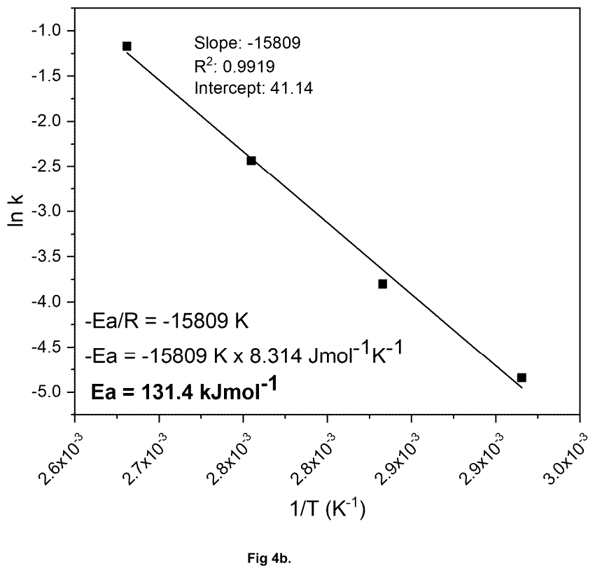

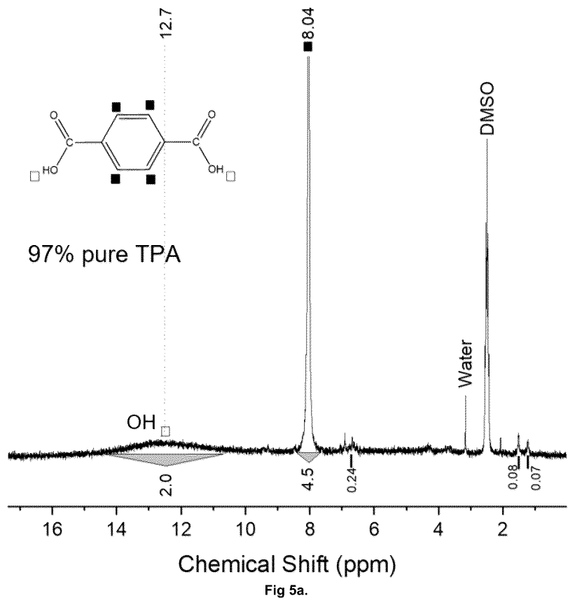

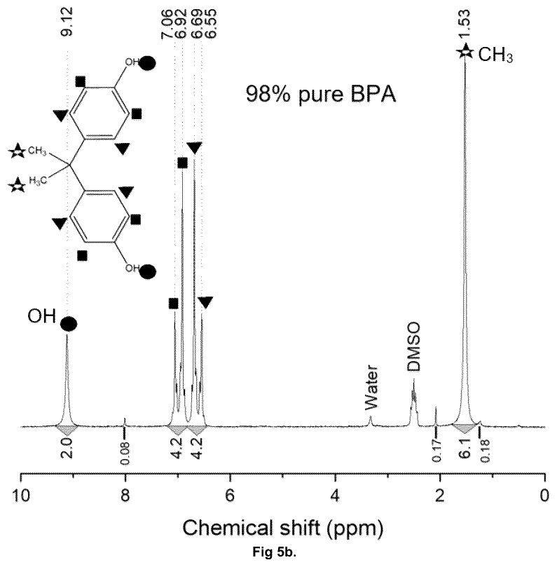

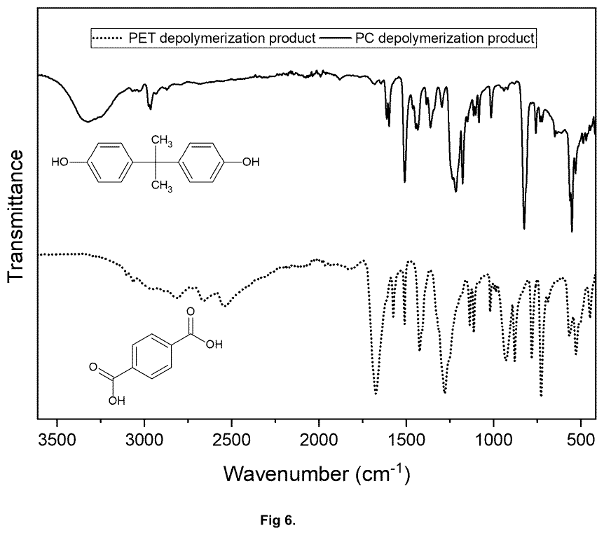

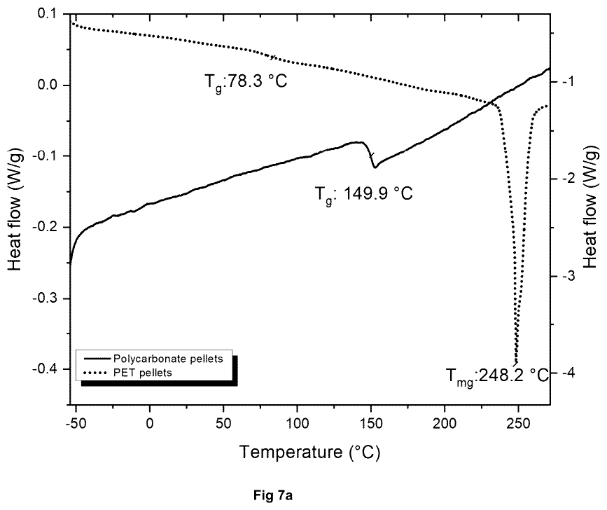

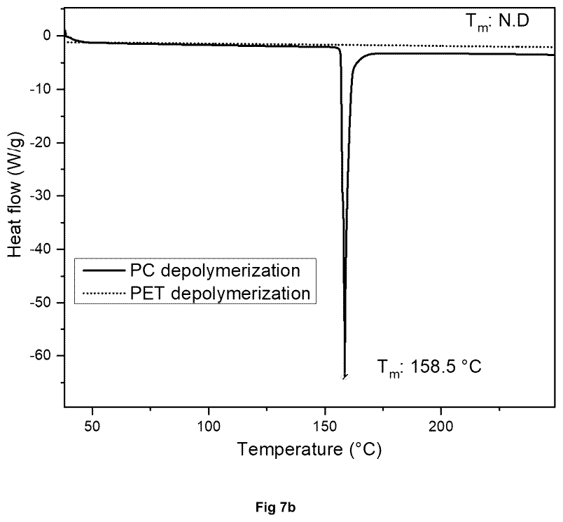

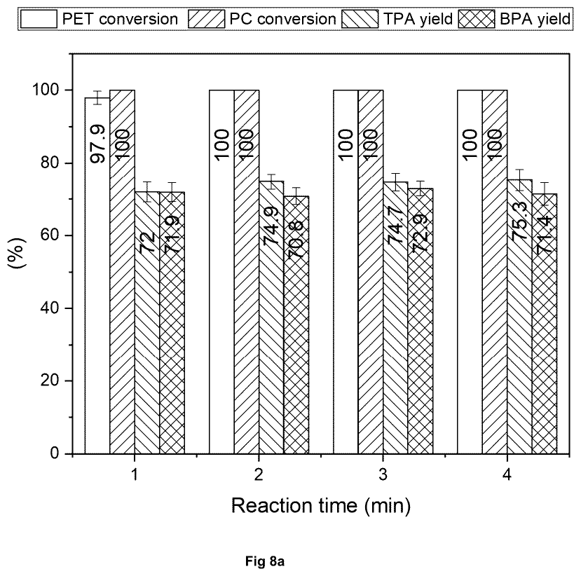

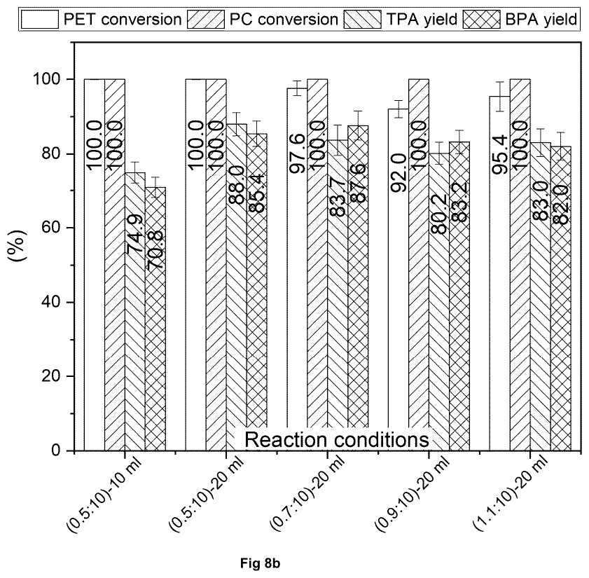

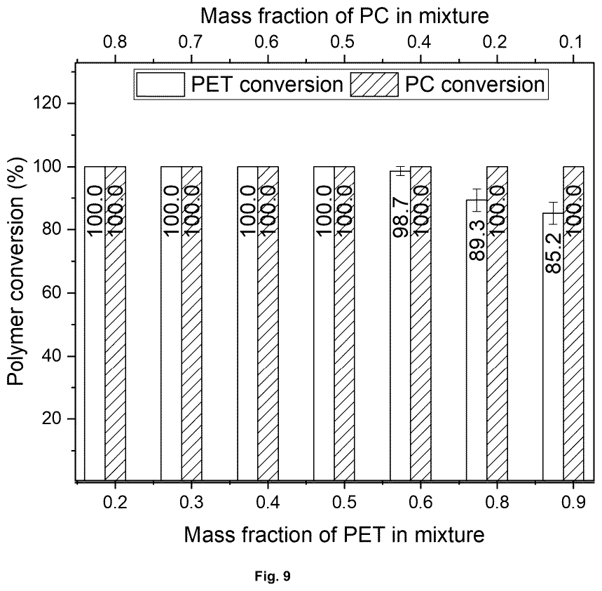

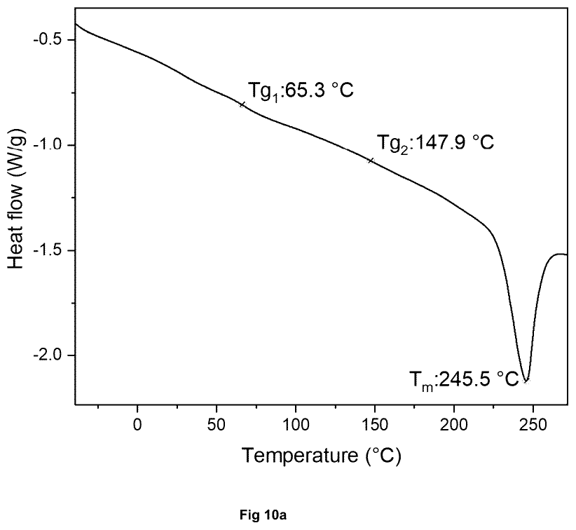

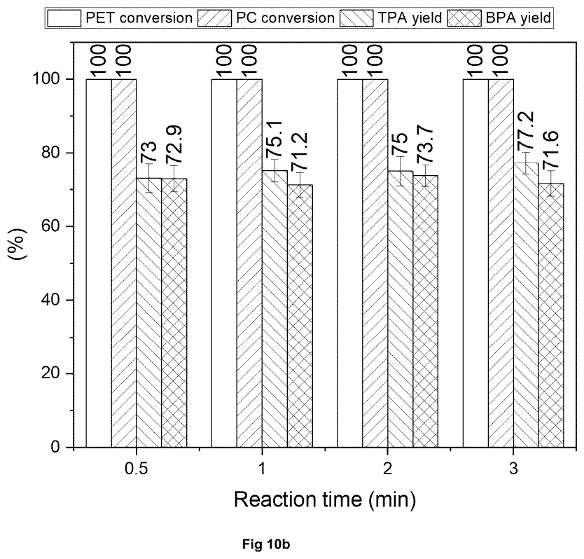

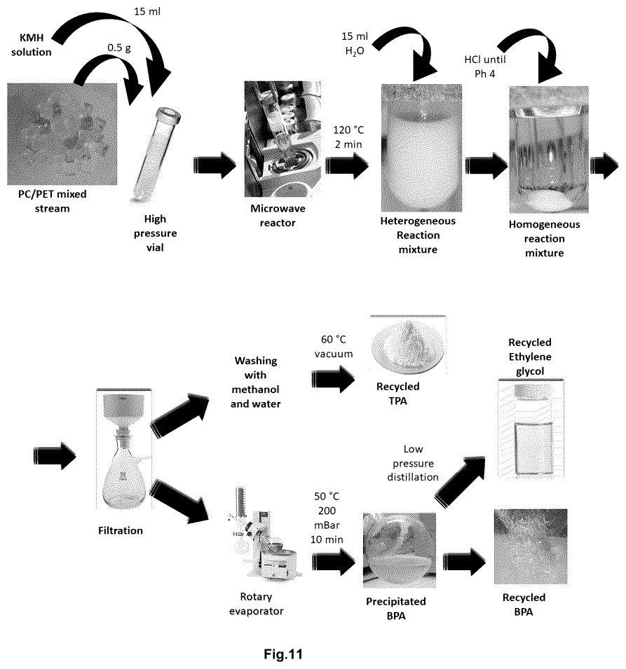

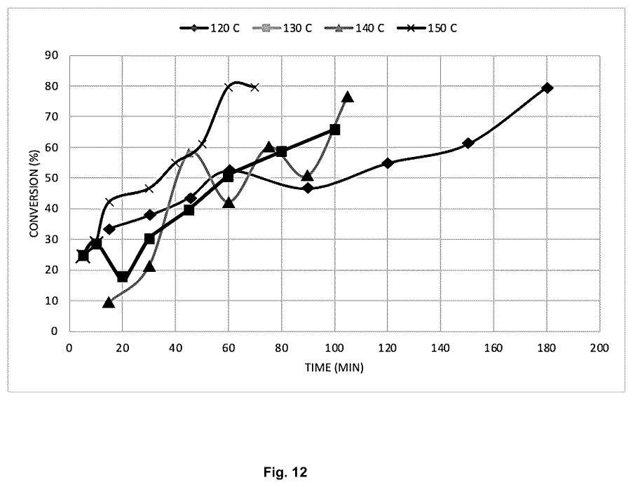

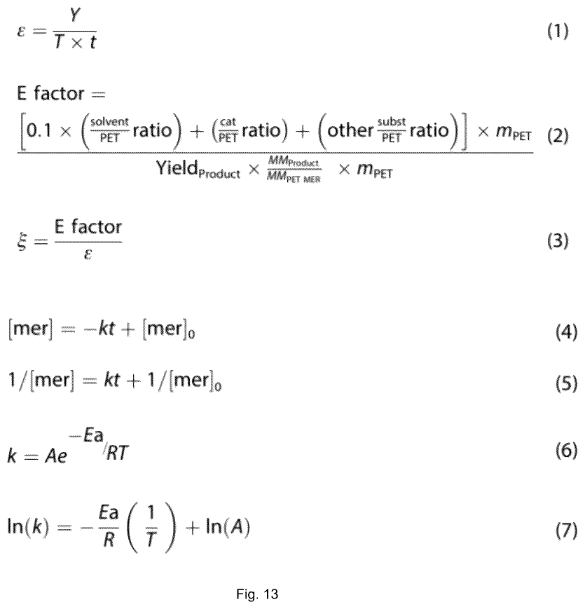

1.-28. (canceled)

29. A method of depolymerizing polymer structures, the method comprising:
a) providing a feedstock comprising polymer microstructures or polymers milli structures or cutting, grinding, shredding or crushing polymer objects or polymer feedstock or a combination of these methods until such are formed into structures with micrometric or millimetric dimension;
b) providing an alkali in alcohol reaction mixture; and
c) subjecting the polymer structure in the alkali in alcohol reaction mixture to microwave assisted heating in a fluid-tight reaction chamber or any other reaction device that avoids or limits pressure loss as a result of heating the reaction mixture;
wherein the depolymerizing comprises a two-step selective depolymerization of one or more polymer structures in a mixture also containing polyamide, comprising in step 1 depolymerizing said one or more polymer structures at 80° C.-130° C. for 2-13 minutes into monomers, and in step 2 depolymerizing said polyamide at 145° C.-155° C. for at least 1.5 h into polyamide monomers or into aminocaproic acid, or hexamethylenediamine and adipic acid;
wherein said one or more polymer structures are selected from the group of polycarbonate, thermoplastic polyester, and polyethylene terephthalate,
wherein said thermoplastic polyester structures, if present, are depolymerized into polyester monomers;
wherein said polycarbonate structures, if present, are depolymerized into polycarbonate monomers or into bisphenol A and dimethyl carbonate; and
wherein said polyethylene terephthalate, if present, are depolymerized into terephthalic acid and ethylene glycol.

30. The method according to claim 29, whereby the structures have a thickness up to 5 mm or have a maximum dimension of not more than 10 mm.

31. The method according to claim 29, whereby the alkali is in an amount of between 1% and 30% by dry weight to provide a reaction mixture.

32. The method according to claim 31, whereby the alkali is in an amount of between 7% and 14% by dry weight to provide a reaction mixture.

33. The method according to claim 29, whereby the polymer structure is between 1% and 50% weight by volume of solution of alkali in alcohol.

34. The method according to claim 33, whereby the polymer structure is between 5% and 20% weight by volume of solution of alkali in alcohol.

35. The method according to claim 29, without any further addition of another organic solvents.

36. The method according to claim 29, wherein the reaction mixture with the polymer structures is maintained at a temperature of between 80° C. and 150° C.

37. A method of depolymerizing polymer structures, the method comprising:
a) providing a feedstock comprising polymer microstructures or polymers milli structures or cutting, grinding, shredding or crushing polymer objects or polymer feedstock or a combination of these methods until such are formed into structures with micrometric or millimetric dimension;
b) providing an alkali in alcohol reaction mixture; and
c) subjecting the polymer structure in the alkali in alcohol reaction mixture to microwave assisted heating in a fluid-tight reaction chamber or any other reaction device that avoids or limits pressure loss as a result of heating the reaction mixture;
wherein the depolymerizing comprises a depolymerization of thermoplastic polyester structures at temperatures ranging from 80° C. to 130° C. for 1 to 13 minutes into their polyester monomers.

38. The method according to claim 37, wherein said thermoplastic polyester is a polyethylene terephthalate and said polyester monomers comprise terephthalic acid and ethylene glycol.

39. The method according to claim 37, whereby the structures have a thickness up to 5 mm or have a maximum dimension of not more than 10 mm.

40. The method according to claim 37, whereby the alkali is in an amount of between 1% and 30% by dry weight to provide a reaction mixture.

41. The method according to claim 40, whereby the alkali is in an amount of between 7% and 14% by dry weight to provide a reaction mixture.

42. The method according to claim 37, whereby the polymer structure is between 1% and 50% weight by volume of solution of alkali in alcohol.

43. The method according to claim 42, whereby the polymer structure is between 5% and 20% weight by volume of solution of alkali in alcohol.

44. The method according to claim 37, without any further addition of another organic solvents.

45. The method according to claim 37, wherein the reaction mixture with the polymer structures is maintained at a temperature of between 80° C. and 150° C.
